(19) United States
(12) Patent Application Publication
(10) Pub. No.: US 2005/0289187 A1
(43) Pub. Date: Dec. 29, 2005

(54) System and method for investigating a data operation performed on a database

(75) Inventors: Daniel Manhung Wong, Sacramento, CA (US); Kristy Browder Edwards, San Francisco, CA (US)

Correspondence Address: ORACLE INTERNATIONAL CORPORATION;c/o A. RICHARD PARK, 2820 FIFTH STREET, DAVIS, CA, 95616-2914, US

(73) Assignee: Oracle International Corporation, Redwood Shores, CA (US)

(21) Appl. No.: 10/879,466

(22) Filed: Jun. 29, 2004

(51) Int. Cl. G06F 7/00

(52) U.S. Cl. 707/200

(57) ABSTRACT

A system and method for investigating a database operation, using forensic analysis. When a database intrusion is detected or suspected, various forensic techniques are applied to trace the intruder's activity and to locate or identify the intruder. An SQL (Structured Query Language) cache may be searched for SQL statements that may comprise SQL injection attacks or that target a particular set of data (e.g., credit card numbers). A System Change Number (SCN) may be used to identify a particular transaction; Undo and/or Redo logs may be reviewed to find other operations performed by the intruder, to retrieve metadata regarding the intruders session and transaction(s). A Flashback utility may be employed to replay the intruder's activity and/or to restore the integrity of the database. If available, an audit trail may also be examined.

### BACKGROUND

This invention relates generally to the fields of computer systems and databases. More particularly, a system and method are provided for investigating an operation performed on a database, using forensic analysis.

Forensic analysis techniques have been used to examine client computing devices employed by single users, to trace actions performed by those dedicated users. Such techniques may be performed under the auspices of a criminal or other legal investigation and may, for example, enable the recovery of files deleted by a user.

Techniques of computer forensic analysis have generally not been applied on server-type computing devices, such as databases and data servers, even though a wealth of data may be stored on such a device or system. The amount and nature of the data may make such devices attractive targets for hackers or information thieves, and therefore the business or other organization that owns the devices possesses a legitimate desire and need to know what occurs on its information technology assets.

Such organizations generally rely upon auditing, intrusion detection systems (IDS) and performance monitoring to track user activity, even on its high value computing devices. Auditing and audit trails facilitate the recovery of data lost or damaged due to human or mechanical error. Thus, an audit log may be reviewed to determine the state or status of a set of data before an error, so that the data can be returned to that state as part of recovery efforts. But, auditing must be configured ahead of time in order to capture a particular type of event. It will not catch the event if it is configured incorrectly or after the event.

Network IDS tools detect intrusions by monitoring a network. These tools do not focus on sensitive data that may be stored in a network database. Performance monitoring tools detect database performance, monitor data storage volumes on disk, transaction volume and so on, but do not focus on monitoring unintended usage of, or access to, sensitive data.

Audit tools are generally configurable to capture any number of a wide range of events. To improve performance and reduce audit log storage requirements, usually only a limited number of events are monitored, resulting in little relevant information when a security breach occurs.

If many events are monitored an audit log may grow very large, and therefore difficult to examine in a detailed manner. Thus, actions taken by a remote user that may be of concern (e.g., viewing credit card numbers, altering terms of a financial transaction) may be lost in a voluminous log, particularly if no security alarms were triggered.

In addition, the establishment of effective auditing usually requires significant time and energy to configure a suitable auditing policy, adjust auditing parameters and review the results. Because of its complexity, in many organizations auditing may not be utilized efficiently, or may not be used at all.

### SUMMARY

In one embodiment of the invention, a system and methods are provided for investigating a database operation, using forensic analysis. When a database intrusion is detected or suspected, various forensic techniques are applied to trace the intruder's activity and to locate or identify the intruder. An SQL (Structured Query Language) cache may be searched for SQL statements that may comprise SQL injection attacks or that target a particular set of data (e.g., credit card numbers). A row level System Change Number (SCN) may be used to identify a particular transaction; Undo and/or Redo logs may be reviewed to find other operations performed by the intruder, to retrieve metadata regarding the intruders session and transaction(s). A Flashback utility may be employed to replay the intruder's activity and/or to restore the integrity of the database. If available, an audit trail may also be examined.

An embodiment of the invention may be particular suitable for investigating data operations performed on a Relational Database Management System (RDBMS) offered by Oracle® Corporation.

### DESCRIPTION OF THE FIGURES

FIG. 1 depicts an illustrative SQL statement that may be executed on an RDBMS.

FIG. 2A depicts an SQL query comprising one form of an SQL injection attack, in accordance with an embodiment of the invention.

FIG. 2B depicts an SQL query comprising a second form of an SQL injection attack, in accordance with an embodiment of the invention.

FIG. 3 is a flowchart illustrating one method of using forensic analysis to investigate an operation performed on a database, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and method are provided for investigating operations performed on a database accessed by multiple users or clients. An investigation may be triggered by actual or suspected database access by an unauthorized person (e.g., hacker, cracker, information thief), or malicious or accidental access by an authorized person (e.g., an employee).

In this embodiment of the invention, the investigation is intended to uncover not only data changes made by an intruder, but may also uncover data that was simply viewed. The term intruder may be used herein to denote a person whose activity is being investigated—whether that person is an insider (e.g., employee) or outsider (e.g., cracker).

An organization's database(s) may be used to store a vast amount of valuable data, such as source code or other electronic products sold by the organization, the organization's human resource information, financial data, strategic plans and policies, etc. In today's computing environments, an organization's data is threatened by many skilled individuals, such as thieves searching for credit card numbers or other financial account information, insiders attempting to alter terms of a financial transaction to benefit themselves, hackers attempting to alter or deny use of a database, etc.

When a break-in, attempted break-in, or other actual or potential data leakage occurs, the organization may have an understandably eager desire to determine the nature and extent of any loss it has suffered, or to identify information that may have been accessed. In addition, legal requirements may dictate notification of governmental or private entities of the loss or compromise of particular information (e.g., credit card numbers).

In embodiments of the invention described herein, computer forensic analysis techniques are applied, along with new or recent advances in relational database management systems (RDBMS), to facilitate an investigation of a database intrusion or possible data loss. An embodiment may be particularly well suited for detecting and tracing an SQL (Structured Query Language) injection attack, in which an intruder includes unexpected input to an input field, to enable access to unauthorized information.

Different embodiments of the invention may employ utilities and metadata available in an RDMBS available from Oracle® Corporation, such as DB_VERIFY, BBED and ORADEBUG, Redo and/or Undo logs (which capture DML (Data Manipulation Language) commands—commands that change data in a database), an SQL cache, audit logs, a Flashback utility and so on. As one skilled in the art will appreciate, database utilities, metadata and the Redo and Undo logs may be maintained as part of an RDBMS, while an audit log must be explicitly set up in advance of an incident. And, an audit log cannot change database data or transactions. Thus, an audit log may not provide the detailed information or capability needed to fully examine or rollback an intruder's actions.

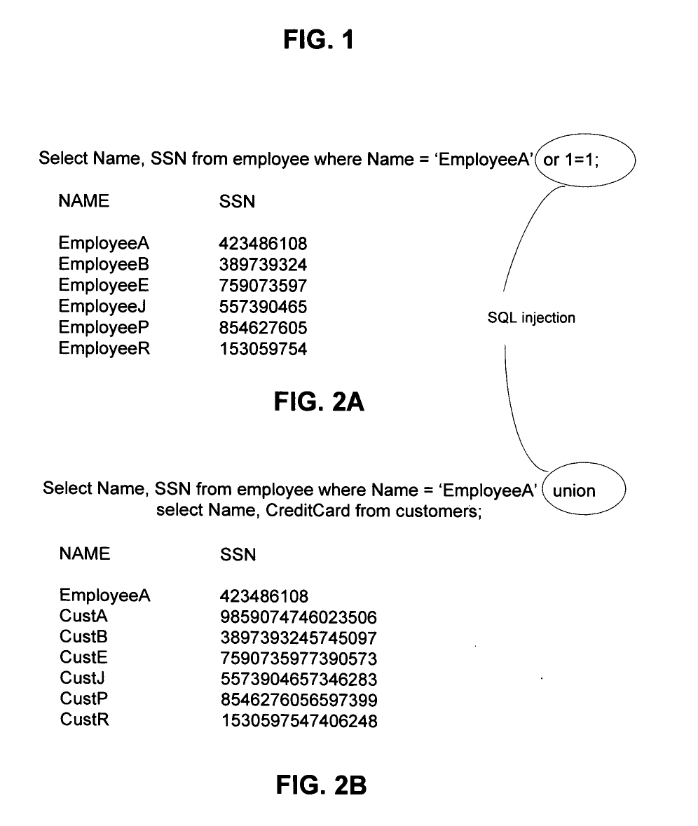

FIG. 1 depicts a typical SQL query that an organization employee (e.g., a human resources manager) may execute in order to find a particular employee's SSN (Social Security Number). FIGS. 2A and 2B illustrate two sample SQL injection attacks, in which an intruder formats queries to cause the retrieval of additional information. In FIG. 2A, the addition of “or 1=1” to the end of the query of FIG. 1 causes the retrieval of SSNs for all employees in the employees table. In FIG. 2B, the addition of “union select name, CreditCard from customers” to a query for an employee's SSN also allows the intruder to access the credit card numbers of all customers in the customers table.

One embodiment of the invention commences by finding an operation known or suspected to be illicit or unauthorized, by searching an SQL cache, Undo log or Redo log. Resources identified above may then be used to determine the transaction and/or session in which the operation occurred. The activity may then be traced to a specific user or process, and to a source computing device or terminal. Other activity during the same transaction or session, and by the same user (or from the same device), may then be traced. The intruder's activity may be replayed to determine what the intruder was able to access and/or how data was altered. Finally, database integrity may be restored by rolling back any number of operations, undoing the intruder's activity, etc.

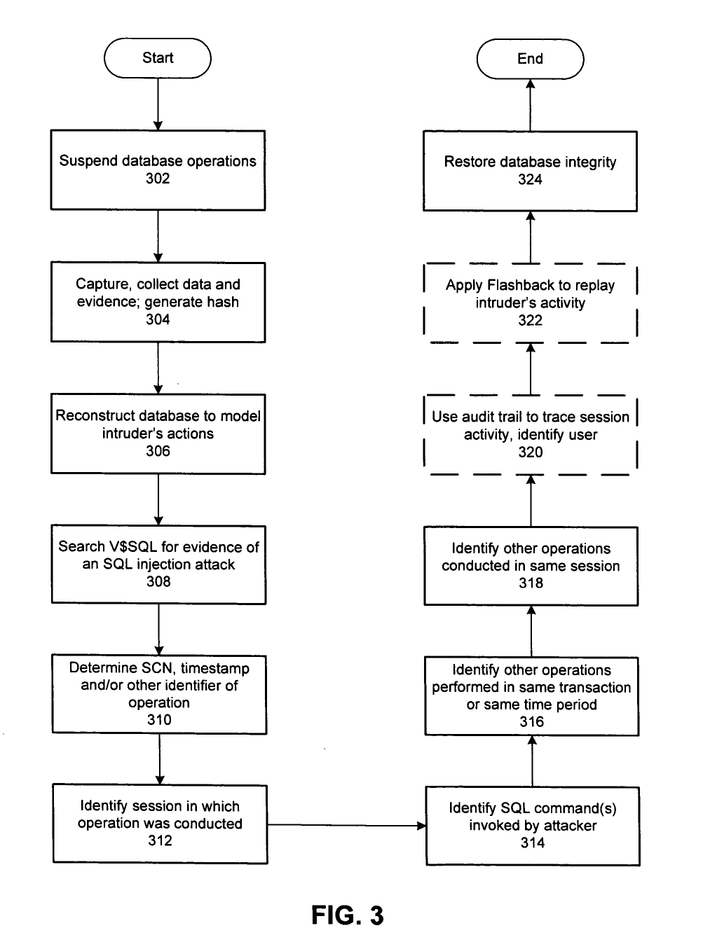

FIG. 3 demonstrates a method of investigating a database operation using computer forensics analysis, according to one embodiment of the invention. As described above, the investigation may be triggered in any manner—by an alarm from an IDS (Intrusion Detection System), detection of an undesired data change, an apparent fraudulent use of data (e.g., credit card abuse), etc. The various actions taken may be performed in different orders, depending on the available evidence.

The method of FIG. 3 is particularly designed for locating and investigating SQL injection attacks on an Oracle RDMBS, in which an intruder views but may or may not change data (e.g., credit card numbers, employees' personal data). Traditional forms of computer forensics are unable to identify data that was viewed, but not changed, by an intruder. Other embodiments of the invention may be derived from this description, to investigate operations in which an intruder alters or corrupts data.

In state 302, database operations are suspended, at least long enough to capture evidence of the intruder's actions. This may entail disabling new logins, terminating any or all existing sessions and disconnecting the database from users (e.g., by disconnecting the database server from any network and/or direct connections).

In state 304, various data relating to database activity and the status of database contents is captured or collected. The data will include evidence of what the intruder did, metadata regarding the intruder's activity. The collected data may include an SQL cache dump (e.g., using the Oracle command “oradebug dump library_cache”), an SGA (System Global Area) dump (e.g., using the Oracle command “oradebug dumpsga”), contents of a swap space, contents of a sort area, various logs (e.g., redo, undo, archive, audit, listener, alert, database trace, network trace), configuration files (e.g., init.ora, sqlnet.ora, tnsnames.ora, a control file) and so on. Any or all data collected in operation 304 may be examined to prove it is authentic or whether it has been tampered with (e.g., by verifying digital signatures or checksums).

As part of state 304, a hash may be computed on any desired set of data (e.g., a disk drive, a database, a database table). Illustratively, the hash may be used to ensure that the database forensics techniques that will be applied have not changed the data, by comparing the hash to a hash generated at another time.

In state 306, the database (or a subset of the database) is reconstructed, on the same or a different database server, to facilitate examination of the intruder's activities and the state of the database before and after the activities. This may entail restoring the database as it appeared some time after the intruder was detected, and then applying an undo log. Or, the database may be restored to a status before the intruder's activity (e.g., from a backup or snapshot) and then a redo log may be applied from that point. The Undo and redo logs may capture all data changes (e.g., DML commands), and may also capture other activity (e.g., Select or Update statements).

Reconstructing the database may entail restoring logs in addition to undo and/or redo logs, replaying contents of an SQL cache (e.g., V$SQL) containing recent SQL statements, mining transaction logs (e.g., DBMS_LOGMNR, Flashback Transaction Monitor) and replaying individual queries and/or transactions (e.g., via Flashback, from an audit trail).

In state 308, the SQL cache (e.g., V$SQL) is searched for evidence of an SQL injection attack. Thus, the cache may be searched for Select and/or Update commands, and/or other potentially exploitable commands, that include “or” or “union”. Or, if a particular table (or specific column or cell) is of concern (e.g., a table of customer credit card numbers), the cache may be searched for the name of that table, column or cell.

In state 310, if a suspect database operation involved a data change, the row level SCN (System Change Number), a timestamp or some other unique identifier of the change may be retrieved in order to identify the individual transaction (e.g., transaction identifier) and/or session (e.g., session identifier) during which the operation was executed. Illustratively, this information may be mined from an undo log.

In state 312, the unique login session identifier for the operation is determined. This may require the use of the SCN, timestamp, or other information. For example, undo, redo and/or other logs may be mined to find session and/or connection information for the transaction or session in which the intruder's operation was conducted.

In state 314, SQL commands or other operations performed by an intruder may be identified, based on SCN, timestamp or other information. For example, information mined from a log may include metadata regarding operations performed by the intruder (e.g., date, time, session identifier, user identifier, client process name, the computing device used by the intruder).

In state 316, a log may be searched to locate other operations performed during the same transaction or time period, or other operations related to the suspect operation. Although every data change operation is associated with a specific transaction and/or session, multiple operations may be conducted during a transaction. A redo or undo log may allow an investigator to replay or reverse a series of changes involving any number of cells in a table, which may allow him or her to closely track the intruder's actions.

In state 318, a log may be searched to locate other operations performed during the same login session, or other operations related to the suspect operation. Although every data change operation is associated with a specific transaction and/or session, multiple operations may be conducted during a session.

In state 320, if auditing was active during the intruder's activity, his or her activity may be traced through available audit logs. For example, an extended audit trail, if available, may provide a logon log and SCNs for the intruder's session, identify other operations performed during that session, other activities initiated from the machine or terminal used by the intruder, etc.

In state 322, a Flashback operation may be performed to rollback the database to a time before the intruder's activity, and/or to replay the intruder's activity. Flashback may be applied to the entire database or to any number of tables in the database. Illustratively, the Flashback monitor may also be employed during any of states 310-314, to obtain various details of the intruder's activity (e.g., time, transaction identifier, data value before and/or after a suspect operation).

In state 324, database integrity is restored using resources such as Flashback, the undo log, the redo log and so on. For example, the database may be restored to a timestamp before the intruder's activity, and then operations other than the intruder's may be replayed. Or, conversely, the database may be restored to its status after the intruder's activity, and the intruder's operation can then be undone. Other utilities, such as BBED or DB_VERIFY may be applied to examine data blocks and fix corrupted data.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

1. A computer-implemented method of investigating a database operation, the method comprising:
suspending database operations;
searching an SQL (Structured Query Language) cache for an SQL injection attack;
identifying a System Change Number (SCN) of an unauthorized database operation;
from said SCN, identifying a transaction ID of a transaction comprising the unauthorized database operation; and
searching one or more of a Redo log and an Undo log for:
information regarding the transaction; and
other operations performed as part of the transaction.

2. The method of claim 1, further comprising:
applying a Flashback utility to replay the unauthorized database operation.

3. The method of claim 1, further comprising:
applying a Flashback utility to restore the database.

4. The method of claim 1, further comprising:
generating a hash on data stored in the database, to facilitate a determination as to whether the investigating of the database operation changed the data.

5. The method of claim 1, wherein said searching one or more of a Redo log and an Undo log further comprises:
identifying a session ID during which the unauthorized database operation was performed.

6. The method of claim 1, wherein said searching one or more of a Redo log and an Undo log further comprises:
identifying a communication connection during which the unauthorized database operation was performed.

7. The method of claim 1, wherein said searching one or more of a Redo log and an Undo log further comprises:
identifying a user that performed the unauthorized database operation.

8. The method of claim 1, wherein said searching one or more of a Redo log and an Undo log further comprises:
searching for a DML (Data Manipulation Language) command.

9. The method of claim 1, further comprising:
searching an audit log to identify an intruder that performed the unauthorized database operation.

10. The method of claim 1, further comprising:
searching an audit log to identify the SCN of the unauthorized database operation.

11. The method of claim 1, further comprising:
searching an audit log to identify a database session during which the unauthorized database operation was performed.

12. The method of claim 11, further comprising:
searching the audit log to identify other operations performed during the database session.

13. The method of claim 1, further comprising:
searching an audit log to identify a computing device from which the unauthorized database operation was initiated.

14. The method of claim 13, further comprising:
searching the audit log to identify a other operations performed from the computing device.

15. The method of claim 1, wherein said searching an SQL cache comprises searching the cache for a Select statement comprising the string “or” or “union”.

16. The method of claim 1, wherein said searching an SQL cache comprises searching the cache for an Update statement comprising the string “or” or “union”.

17. A computer readable medium storing instructions that, when executed by a computer, cause the computer to perform a method of investigating a database operation, the method comprising:
suspending database operations;
searching an SQL (Structured Query Language) cache for an SQL injection attack;
identifying a System Change Number (SCN) of an unauthorized database operation;
from said SCN, identifying a transaction ID of a transaction comprising the unauthorized database operation; and
searching one or more of a Redo log and an Undo log for:
information regarding the transaction; and
other operations performed as part of the transaction.

18. An apparatus for investigating a database operation, comprising:
a relational database management system (RDBMS);
an SQL (Structured Query Language) cache comprising SQL statements recently executed against the RDBMS;
a Redo log facilitating the re-execution of RDBMS activity from a first timestamp to a later timestamp;
an Undo log facilitating the undoing of RDBMS activity from a second timestamp to an earlier timestamp; and
a Flashback utility configured to facilitate rapid restoration of contents of the RDBMS.

19. The apparatus of claim 18, wherein each operation on the RDBMS that alters contents of the RDBMS is assigned an SCN (System Change Number).

20. The apparatus of claim 18, further comprising:
an audit trail of user activity relating to a server computer hosting the RDBMS.

21. The apparatus of claim 18, further comprising:
means for searching the SQL cache for possible SQL injection attacks.

22. The apparatus of claim 18, further comprising:
means for searching the Redo log or the Undo log for an unauthorized operation on the RDBMS.

23. The apparatus of claim 22, wherein the unauthorized operation comprises an SQL injection attack.

24. The apparatus of claim 18, further comprising:
means for searching the Redo log or the Undo log for information relating to an unauthorized operation on the RDBMS.

25. The apparatus of claim 18, further comprising:
means for determining the SCN of an unauthorized operation on the RDBMS.

26. The apparatus of claim 25, further comprising:
means for determining the transaction ID of the unauthorized operation.

27. The apparatus of claim 26, further comprising:
means for identifying other operations performed under the transaction ID.

28. The apparatus of claim 25, further comprising:
means for identifying a session during which the unauthorized operation was performed.

29. The apparatus of claim 28, further comprising:
means for identifying other operations performed during the session.

30. The apparatus of claim 25, further comprising:
means for identifying a communication connection during which the unauthorized operation was performed.
